(19) United States
(12) Patent Application Publication
(10) Pub. No.: US 2025/0391286 A1
(43) Pub. Date: Dec. 25, 2025

(54) SYSTEM AND METHOD FOR PROVIDING GAMING INTERFACES TO TEST DRIVING-RELATED COGNITIVE FUNCTIONS

(71) Applicant: Quanata, LLC, San Francisco, CA (US)

(72) Inventor: Gil Tamari, San Francisco, CA (US)

(73) Assignee: Quanata, LLC, San Francisco, CA (US)

(21) Appl. No.: 18/751,636

(22) Filed: Jun. 24, 2024

(51) Int. Cl. G09B 9/052; A63F 13/216; G06Q 40/08

(52) U.S. Cl. CPC G09B 9/052; A63F 13/216; G06Q 40/08

(57) ABSTRACT

A method including transmitting, to a user device of a user, a graphical user interface for display on the user device is disclosed. The graphical user interface can include one or more activation controls for activating one or more gaming interfaces. The one or more gaming interfaces can include one or more visual prompts to cause one or more user interactions with the one or more gaming interfaces by the user. The method further can include upon determining that at least one of the one or more gaming interfaces is activated, receiving, from the user device, gaming performance data associated with the one or more user interactions. The method additionally can include determining, by the one or more processors, one or more cognitive factors for the user based on the gaming performance data. The method also can include generating, by the one or more processors, an output associated with the user based at least in part on the one or more cognitive factors, as determined. Other embodiments are disclosed.

### FIELD OF THE DISCLOSURE

The present disclosure generally relates to using computer gaming to evaluate users' cognitive functions.

### BACKGROUND

A person's fitness-to-drive a vehicle is a concern to the public. An unfit driver not only puts the driver in danger, but also risks the safety of others. Auto insurance companies can also suffer loss by not being able to correctly identify fit and unfit drivers during the application and/or renewal process of insurance policies. Among other factors, some cognitive skills (e.g., working memory, attention, visual processing, etc.) are known to affect a person's driving performance, and conventional approaches generally estimate a person's cognitive functions categorically based on the person's age and/or diseases or generally rely on the person's subjective evaluation of his/her own cognitive skills. However, in addition to the difficulties in accessing the person's health data, the person's age might not correctly reflect the person's fitness to drive. Therefore, systems and methods for easily testing a person's cognitive skills for driving a vehicle without physical exams are desired.

### BRIEF DESCRIPTION OF THE DRAWINGS

The figures described below depict various aspects of the systems and methods disclosed therein. It should be understood that each figure depicts an embodiment of a particular aspect of the disclosed systems and methods, and that each of the figures is intended to accord with a possible embodiment thereof. Further, wherever possible, the following description refers to the reference numerals included in the following figures, in which features depicted in multiple figures are designated with consistent reference numerals.

There are shown in the drawings arrangements which are presently discussed, it being understood, however, that the present embodiments are not limited to the precise arrangements and are instrumentalities shown, wherein:

FIG. 1 illustrates a front elevation view of a computer system that is suitable for implementing an exemplary embodiment of the system disclosed in FIG. 3;

FIG. 2 illustrates a representative block diagram of an example of the elements included in the circuit boards inside a chassis of the computer system of FIG. 1;

FIG. 3 illustrates a system for providing one or more gaming interfaces to determine one or more cognitive factors for a user based on the user's gaming performance, according to one exemplary embodiment;

FIG. 4 illustrates a flow chart for a method for providing one or more gaming interfaces to determine one or more cognitive factors for a user based on the user's gaming performance, according to one exemplary embodiment;

FIG. 5 illustrates an exemplary displayed content of a display device showing exemplary user interfaces for determining a user's gaming performance, according to one exemplary embodiment; and

FIG. 6 illustrates an exemplary gaming interface for displaying a game, according to one exemplary embodiment.

The figures depict preferred embodiments for purposes of illustration only. One skilled in the art will readily recognize from the following discussion that alternative embodiments of the systems and methods illustrated herein can be employed without departing from the principles of the technology described herein.

### DETAILED DESCRIPTION OF THE DRAWINGS

The present embodiments can generally relate to, inter alia, providing user interfaces configured to test driving-related cognitive functions. Driving-related cognitive functions of a user can provide valuable information for determining the user's fitness-to-drive, and can form an important basis, or a portion thereof, for improving courses of action by entities, such as price changes, product or service changes or modifications, employment decisions, company policy changes impacting employees, reward policy changes, etc.

More specifically, various embodiments can include a method for providing a graphical user interface with one or more gaming interfaces to test driving-related cognitive functions. The method can include: (a) transmitting, to a user device of a user, a graphical user interface for display on the user device, wherein the graphical user interface comprises one or more activation controls for activating one or more gaming interfaces that comprise one or more gaming controls associated with one or more visual prompts to cause one or more user interactions with the one or more gaming interfaces by the user; (b) upon determining that at least one of the one or more gaming interfaces is activated, receiving, from the user device, gaming performance data associated with the one or more user interactions; (c) determining, by the one or more processors, one or more cognitive factors for the user based on the gaming performance data; and (d) generating, by the one or more processors, an output associated with the user based at least in part on the one or more cognitive factors, as determined. The method can include additional, less, or alternate functionality, including that discussed elsewhere herein.

In one aspect, a system for providing a graphical user interface with one or more gaming interfaces to test driving-related cognitive functions can be provided. The computer system can include one or more local or remote processors, servers, sensors, memory units, transceivers, mobile devices, wearables, smart watches, smart rings, smart glasses or contacts, augmented reality glasses, virtual reality headsets, mixed or extended reality headsets, voice bots, chat bots, ChatGPT bots, InstructGPT bots, Codex bots, Google Bard bots, and/or other electronic or electrical components, which can be in wired or wireless communication with one another. For instance, in one aspect, the computer system can include one or more local or remote processors and/or associated transceivers; and one or more local or remote non-transitory computer-readable media storing computing instructions that, when run on the one or more processors, direct the one or more processors to perform one or more actions or operations.

The computing instructions can direct the systems and/or processor(s) to: (a) transmit, to a user device of a user, a graphical user interface for display on the user device, wherein the graphical user interface comprises one or more activation controls for activating one or more gaming interfaces that comprise one or more gaming controls associated with one or more visual prompts to cause one or more user interactions with the one or more gaming interfaces by the user; (b) upon determining that at least one of the one or more gaming interfaces is activated, receive, from the user device, gaming performance data associated with the one or more user interactions; (c) determine, by the one or more processors, one or more cognitive factors for the user based on the gaming performance data; and (d) generate, by the one or more processors, an output associated with the user based at least in part on the one or more cognitive factors, as determined. The system can be configured to include additional, less, or alternate functionality, including that discussed elsewhere herein.

In another aspect, a computer readable storage medium storing computing instructions can be provided. The computing instructions, when run on one or more processors, can cause the one or more processors to: (a) transmit, to a user device of a user, a graphical user interface for display on the user device, wherein the graphical user interface comprises one or more activation controls for activating one or more gaming interfaces that comprise one or more gaming controls associated with one or more visual prompts to cause one or more user interactions with the one or more gaming interfaces by the user; (b) upon determining that at least one of the one or more gaming interfaces is activated, receive, from the user device, gaming performance data associated with the one or more user interactions; (c) determine, by the one or more processors, one or more cognitive factors for the user based on the gaming performance data; and (d) generate, by the one or more processors, an output associated with the user based at least in part on the one or more cognitive factors, as determined. The computer readable storage medium can be configured to include additional, less, or alternate functionality, including that discussed elsewhere herein.

Advantages will become more apparent to those skilled in the art from the following description of the preferred embodiments which have been shown and described by way of illustration. As will be realized, the present embodiments can be capable of other and different embodiments, and their details are capable of modification in various respects. Accordingly, the drawings and description are to be regarded as illustrative in nature and not as restrictive.

The user interfaces configured to test driving-related cognitive functions, as mentioned above, can include gaming interfaces configured to determine one or more cognitive factors for a user based on the user's gaming performance. The one or more cognitive factors can be used to, for example, determine a discount value for an auto or health insurance policy, make an employment decision about professional drivers, evaluate a driver's fitness to driver for renewing the driver's license, etc.

In many embodiments, the techniques described herein can provide a practical application and several technological improvements. The techniques described herein can provide a technical improvement to user interfaces for testing cognitive skills. In particular, the techniques described here may provide a graphical user interface configured to be displayed on a computer device with one or more activation controls configured to activate one or more gaming interfaces for proactively determining a user's cognitive functions. The one or more gaming interfaces can be personalized based on the user's demographic and/or geographic information. These techniques described herein can provide a significant improvement over conventional approaches that either (a) use a self-reporting approach or a categorical approach to predict the user's cognitive functions based on the user's judgement or the user's age, which thus can be biased or inaccurate, or (b) monitor the user's driving performance for a period of time after an insurance policy or a driver's license is renewed, which can be reactive.

In certain aspects, a method can include transmitting, to a user device of a user, a graphical user interface for display on the user device. The graphical user interface can include one or more activation controls for activating one or more gaming interfaces. The one or more gaming interfaces can include one or more gaming controls associated with one or more visual prompts to cause one or more user interactions with the one or more gaming interfaces by the user. The method further can include upon determining that at least one of the one or more gaming interfaces is activated, receiving, from the user device, gaming performance data associated with the one or more user interactions. Moreover, the method can include determining, by the one or more processors, one or more cognitive factors for the user based on the gaming performance data. Additionally, the method can include generating, by the one or more processors, an output associated with the user based at least in part on the one or more cognitive factors, as determined.

### Exemplary Computer Systems

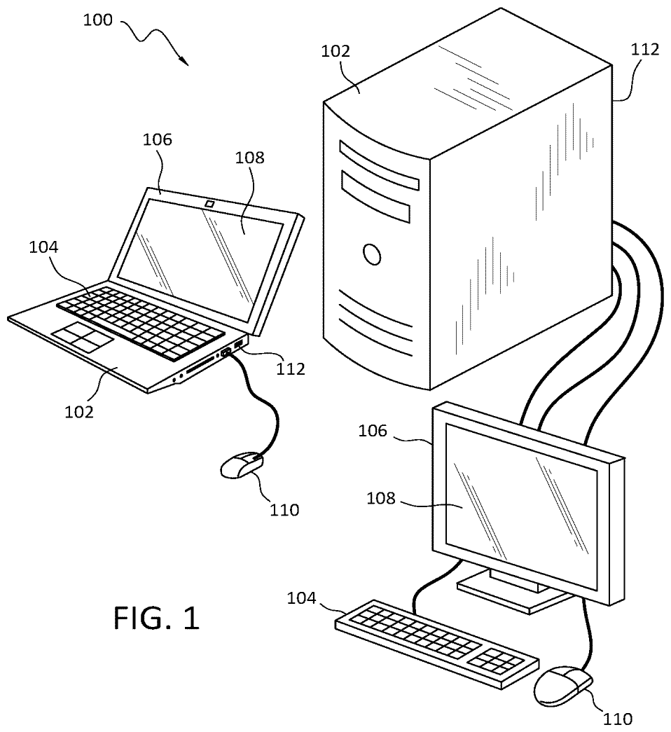

Turning to the drawings, FIG. 1 illustrates an exemplary embodiment of two different types (e.g., a laptop and a tower server) of a computer system 100, all of which or a portion of which can be suitable for (i) implementing part or all of one or more embodiments of the techniques, methods, and systems and/or (ii) implementing and/or operating part or all of one or more embodiments of the non-transitory computer readable media described herein. As an example, a different or separate one of computer system 100 (and its internal components, or one or more elements of computer system 100) can be suitable for implementing part, or all of, the techniques described herein. Computer system 100 can comprise chassis 102 containing one or more circuit boards (not shown) and one or more of an input/output port 112 (e.g., one or more universal serial bus (USB) ports of one or more types (e.g., USB type-A, type-B, type-C, micro-A, micro-B, mini-A, mini-B, etc.), one or more High-Definition Multimedia Interface (HDMI) ports, etc.).

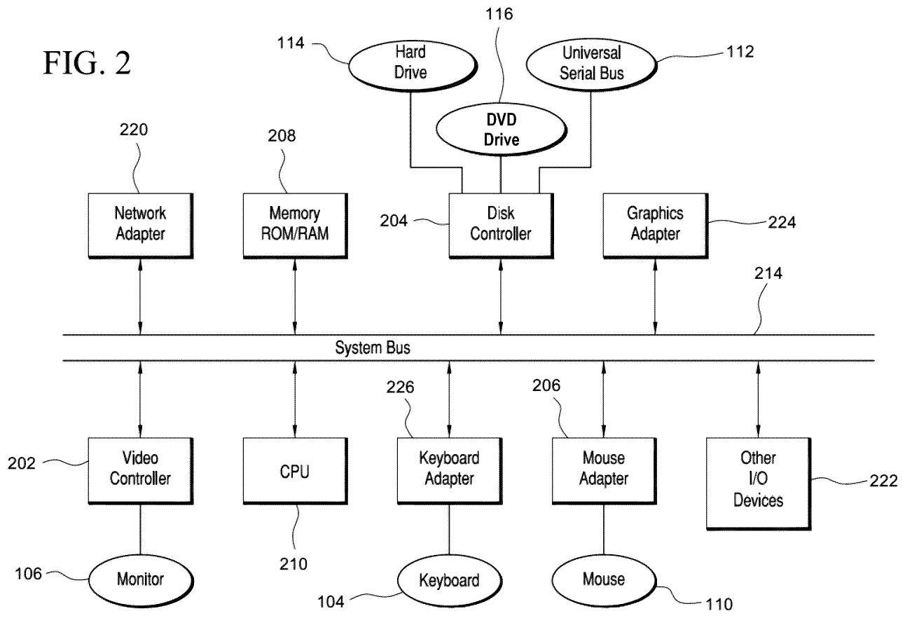

A representative block diagram of the elements included on the circuit boards inside chassis 102 is shown in FIG. 2. A central processing unit (CPU) 210 in FIG. 2 is coupled to a system bus 214. In various embodiments, the architecture of CPU 210 can be compliant with any of a variety of commercially distributed architecture families.

Continuing with FIG. 2, system bus 214 can also be coupled to memory storage unit 208 that includes both read only memory (ROM) and random access memory (RAM). Non-volatile portions of memory storage unit 208 or the ROM can be encoded with a boot code sequence suitable for restoring computer system 100 (FIG. 1) to a functional state after a system reset. In addition, memory storage unit 208 can include microcode such as a Basic Input-Output System (BIOS). In some examples, the one or more memory storage units of the various embodiments disclosed herein can include memory storage unit 208, a USB-equipped electronic device (e.g., an external memory storage unit (not shown) coupled to input/output port 112 (FIGS. 1-2)), hard drive 114 (FIG. 2), and/or one or more CD-ROM, DVD, Blu-Ray, or other suitable media, such as media configured to be used in a CD-ROM and/or DVD drive 116 (FIG. 2) inside chassis 102 (FIG. 1) or in a detachable drive coupled to input/output port 112.

Non-volatile or non-transitory memory storage unit(s) refer to the portions of the memory storage units(s) that are non-volatile memory and not a transitory signal. In the same or different examples, the one or more memory storage units of the various embodiments disclosed herein can include an operating system, which can be a software program that manages the hardware and software resources of a computer and/or a computer network. The operating system can perform basic tasks such as, for example, controlling and allocating memory, prioritizing the processing of instructions, controlling input and output devices, facilitating networking, and managing files. Exemplary operating systems can include one or more of the following: (i) Microsoft® Windows® operating system (OS) by Microsoft Corp. of Redmond, Washington, United States of America, (ii) Mac® OS X by Apple Inc. of Cupertino, California, United States of America, (iii) UNIX® OS, and (iv) Linux® OS.

Further exemplary operating systems can comprise one of the following: (i) the iOS® operating system by Apple Inc. of Cupertino, California, United States of America, (ii) the Blackberry® operating system by Research In Motion (RIM) of Waterloo, Ontario, Mayada, (iii) the WebOS operating system by LG Electronics of Seoul, South Korea, (iv) the Android™ operating system developed by Google, of Mountain View, California, United States of America, (v) the Windows Mobile™ operating system by Microsoft Corp. of Redmond, Washington, United States of America, or (vi) the Symbian™ operating system by Accenture PLC of Dublin, Ireland.

As used herein, “processor” and/or “processing module” means any type of computational circuit, such as but not limited to a microprocessor, a microcontroller, a controller, a complex instruction set computing (CISC) microprocessor, a reduced instruction set computing (RISC) microprocessor, a very long instruction word (VLIW) microprocessor, a graphics processor, a digital signal processor, or any other type of processor or processing circuit capable of performing the desired functions. In some examples, the one or more processors of the various embodiments disclosed herein can comprise CPU 210.

In the depicted embodiment of FIG. 2, various I/O devices such as a disk controller 204, a graphics adapter 224, a video controller 202, a keyboard adapter 226, a mouse adapter 206, a network adapter 220, and other I/O devices 222 can be coupled to system bus 214. Keyboard adapter 226 and mouse adapter 206 can be coupled to a keyboard 104 (FIGS. 1-2) and a mouse 110 (FIGS. 1-2), respectively, of computer system 100 (FIG. 1). While graphics adapter 224 and video controller 202 are indicated as distinct units in FIG. 2, video controller 202 can be integrated into graphics adapter 224, or vice versa in other embodiments. Video controller 202 is suitable for refreshing a monitor 106 (FIGS. 1-2) to display images on a screen 108 (FIG. 1) of computer system 100 (FIG. 1). Disk controller 204 can control hard drive 114 (FIG. 2), input/output port 112 (FIGS. 1-2), and CD-ROM and/or DVD drive 116 (FIG. 2). In other embodiments, distinct units can be used to control each of these devices separately.

In some embodiments, network adapter 220 can comprise and/or be implemented as a WNIC (wireless network interface controller) card (not shown) plugged or coupled to an expansion port (not shown) in computer system 100 (FIG. 1). In other embodiments, the WNIC card can be a wireless network card built into computer system 100 (FIG. 1). A wireless network adapter can be built into computer system 100 by having wireless communication capabilities integrated into the motherboard chipset (not shown), and/or implemented via one or more dedicated wireless communication chips (not shown), connected through a PCI (peripheral component interconnector) or a PCI express bus of computer system 100 (FIG. 1) or input/output port 112 (FIG. 1). In other embodiments, network adapter 220 can comprise and/or be implemented as a wired network interface controller card (not shown).

Although many other components of computer system 100 are not shown, such components and their interconnection are well known to those of ordinary skill in the art. Accordingly, further details concerning the construction and composition of computer system 100 and the circuit boards inside chassis 102 are not discussed herein.

When computer system 100 in FIG. 1 is running, program instructions stored on a USB drive in input/output port 112, on a CD-ROM or DVD in CD-ROM and/or DVD drive 116 (FIG. 2) or in the detachable CD-ROM and/or DVD drive coupled to input/output port 112, on hard drive 114 (FIG. 2), or in memory storage unit 208 (FIG. 2) are executed by CPU 210 (FIG. 2). A portion of the program instructions, stored on these devices, can be suitable for carrying out all or at least part of the techniques described herein. In various embodiments, computer system 100 can be reprogrammed with one or more modules, system, applications, and/or databases, such as those described herein, to convert a general purpose computer to a special purpose computer.

For purposes of illustration, programs and other executable program components are shown herein as discrete systems, although it is understood that such programs and components can reside at various times in different storage components of computer system 100, and such programs and other executable program components can be executed by CPU 210. Alternatively, or in addition to, the systems and procedures described herein can be implemented in hardware, or a combination of hardware, software, and/or firmware. For example, one or more application specific integrated circuits (ASICs) can be programmed to carry out one or more of the systems and procedures described herein. For example, one or more of the programs and/or executable program components described herein can be implemented in one or more ASICs.

Although computer system 100 is illustrated as a laptop computer or a tower server in FIG. 1, there can be examples where computer system 100 can take a different form factor while still having functional elements similar to those described for computer system 100. In some embodiments, computer system 100 can comprise a single computer, a single server, or a cluster or collection of computers or servers, or a cloud of computers or servers. Typically, a cluster or collection of servers can be used when the demand on computer system 100 exceeds the reasonable capability of a single server or computer. In certain embodiments, computer system 100 can comprise a portable computer, such as a laptop computer. In certain other embodiments, computer system 100 can comprise a mobile device, such as a smartphone, smart glasses, smart watch, smart rings, wearable, virtual reality headset, augmented reality glasses, etc. In certain additional embodiments, computer system 100 can comprise an embedded system.

### Exemplary Computer Systems for Generating an Output Based on Cognitive Factors for a User Determined According to the User'S Gaming Performance

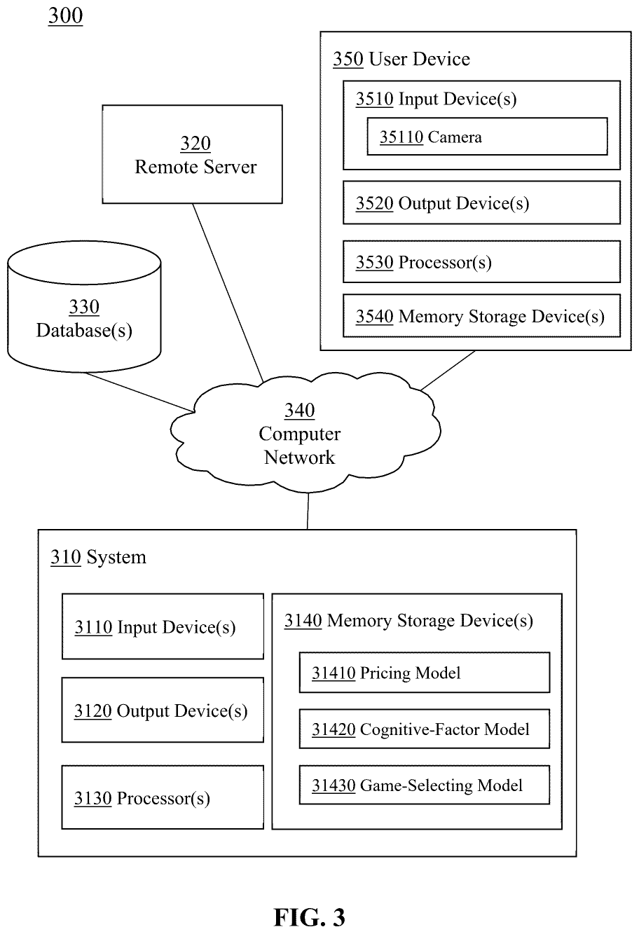

Turning ahead in the drawings, FIG. 3 illustrates a block diagram of a computer system 300 for providing gaming interfaces, determining the user's cognitive factors based on gaming performance, and generating an output based at least in part on the cognitive factors, according to one embodiment. System 300 is exemplary, and embodiments of the system are not limited to the embodiments presented herein. The system can be employed in many different embodiments or examples not specifically depicted or described herein. In some embodiments, certain elements, modules, or systems of system 300 can perform various procedures, processes, operations, actions, and/or activities. In other embodiments, the procedures, processes, operations, actions, and/or activities can be performed by other suitable elements, modules, or systems of system 300.

Generally, therefore, system 300 can be implemented with hardware and/or software, as described herein. In some embodiments, part or all of the hardware and/or software can be conventional, while in these or other embodiments, part or all of the hardware and/or software can be customized (e.g., optimized) for implementing part or all of the functionality of system 300 described herein.

In some embodiments, system 300 can include one or more systems (e.g., a system 310), one or more remote servers (e.g., a remote server 320), and/or one or more user devices (e.g., a user device 350). System 310, remote server 320, and user device 350 can each be a computer system, such as computer system 100 (FIG. 1), as described above, and can each be a single computer, a single server, or a cluster or collection of computers or servers, or a cloud of computers or servers. In another embodiment, a single computer system can host each of system 310, remote server 320, and user device 350.

In many embodiments, system 310 can be modules of computing instructions (e.g., software modules) stored on non-transitory computer readable media that operate on one or more processors. In other embodiments, system 310 can be implemented in hardware. In many embodiments, system 310 can comprise one or more systems, subsystems, modules, models, or servers (e.g., a pricing model 31410, a cognitive-factor model 31420, a game-selecting model 31430, etc.). Each pricing model 31410, cognitive-factor model 31420, and game-selecting model 31430 can be implemented, at least in part, in software and/or firmware stored in or loaded on memory storage device(s) 3140 and executed on processor(s) 3130. Additional details regarding system 310, remote server 320, and/or user device 350 are described herein.

In some embodiments, system 310 can be in data communication, through a computer network, a telephone network, or the Internet (e.g., computer network 340), with remote server 320, and/or user device 350. In some embodiments, user device 350 can be used by users, such as users for system 310 and/or remote server 320 (e.g., an insurance policyholder, an applicant for an auto insurance policy or a professional driver's job, etc.).

In certain embodiments, system 310 and/or remote server 320 can host one or more websites and/or mobile application servers. For example, system 310 and/or remote server 320 can host a website, or provide a server that interfaces with an application (e.g., a mobile application or a web browser), on user device 350, which can allow users to download gaming interfaces and/or interact with (e.g., play, configure, pause, etc.) gaming interfaces (downloaded or executed on system 310 and/or remote server 320) configured to determine the users' gaming performance associated with cognitive factors, in addition to other suitable activities. In some embodiments, an internal network (e.g., computer network 340) that is not open to the public can be used for communications between system 310 and remote server 320 and/or user device 350 within system 300.

In many embodiments, user device 350 can include one or more input devices (e.g., input device(s) 3510), one or more output devices (e.g., output device(s) 3520), one or more processors (e.g., processor(s) 3530), and/or one or more memory storage devices (e.g., memory storage device(s) 3540). Examples of input device(s) 3510 can include one or more keyboards, one or more keypads, one or more pointing devices such as a computer mouse or computer mice, one or more touchscreen displays, a microphone, a camera, keyboard 104 (FIG. 1), mouse 110 (FIG. 1), etc. Examples of output device(s) 3520 can include one or more monitors, one or more touch screen displays, projectors, monitor 106 (FIG. 1), screen 108 (FIG. 1), etc. Examples of processor(s) 3530 can include CPU 210 (FIG. 2), etc. Examples of memory storage device(s) 3540 can include memory storage unit 208 (FIG. 2), external storage units coupled to input/output port 112 (FIGS. 1-2), hard drive 114 (FIG. 2), CD-ROM and/or DVD drive 116 (FIG. 2), a detachable drive coupled to input/output port 112 (FIGS. 1-2), etc. In a number of embodiments, input device(s) 3510 further can include one or more cameras (e.g., a camera 35110, etc.) and/or one or more microphones.

Input device(s) 3510 and output device(s) 3520 can be coupled to user device 350 in a wired manner and/or a wireless manner, and the coupling can be direct and/or indirect, as well as locally and/or remotely. As an example of an indirect manner (which can or cannot also be a remote manner), a keyboard-video-mouse (KVM) switch can be used to couple input device(s) 3510 and output device(s) 3520 to processor(s) 3530 and/or memory storage device(s) 3540. In some embodiments, the KVM switch also can be part of user device 350. In a similar manner, processor(s) 3530 and/or memory storage device(s) 3540 can be local and/or remote to each other.

In certain embodiments, the user devices (e.g., user device 350) can be a mobile device, and/or other endpoint devices used by one or more users. A mobile device can refer to a portable electronic device (e.g., an electronic device easily conveyable by hand by a person of average size) with the capability to present audio and/or visual data (e.g., text, images, videos, music, etc.). For example, a mobile device can include at least one of a digital media player, a cellular telephone (e.g., a smartphone), a personal digital assistant, a handheld digital computer device (e.g., a tablet personal computer device), a laptop computer device (e.g., a notebook computer device, a netbook computer device), a wearable user computer device (e.g., smart glasses, smart watches, smart rings, an augmented-reality (AR) headset, a virtual-reality (VR) headset, etc.), or another portable computer device with the capability to present audio and/or visual data (e.g., images, videos, music, etc.).

Thus, in many examples, a mobile device can include a volume and/or weight sufficiently small as to permit the mobile device to be easily conveyable by hand. For examples, in some embodiments, a mobile device can occupy a volume of less than or equal to approximately 1790 cubic centimeters, 2434 cubic centimeters, 2876 cubic centimeters, 4056 cubic centimeters, and/or 5752 cubic centimeters. Further, in these embodiments, a mobile device can weigh less than or equal to 15.6 Newtons, 17.8 Newtons, 22.3 Newtons, 31.2 Newtons, and/or 44.5 Newtons.

Exemplary mobile devices can include (i) an iPod®, iPhone®, iTouch®, iPad®, MacBook® or similar product by Apple Inc. of Cupertino, California, United States of America, (ii) a Blackberry® or similar product by Research in Motion (RIM) of Waterloo, Ontario, Mayada, (iii) a Lumia® or similar product by the Nokia Corporation of Keilaniemi, Espoo, Finland, and/or (iv) a Galaxy™ or similar product by the Samsung Group of Samsung Town, Seoul, South Korea. Further, in the same or different embodiments, a mobile device can include an electronic device configured to implement one or more of (i) the iPhone® operating system by Apple Inc. of Cupertino, California, United States of America, (ii) the Blackberry® operating system by Research In Motion (RIM) of Waterloo, Ontario, Mayada, (iii) the Android™ operating system developed by the Open Handset Alliance, or (iv) the Windows Mobile™ operating system by Microsoft Corp. of Redmond, Washington, United States of America.

In many embodiments, system 310 can include: (a) one or more input devices (e.g., input device(s) 3110 such as one or more keyboards, one or more keypads, one or more pointing devices such as a computer mouse or computer mice, one or more touchscreen displays, a microphone, a camera, etc.), (b) one or more display or output devices (e.g., output device(s) 3120 such as one or more monitors, one or more touch screen displays, projectors, etc.), (c) one or more processors (e.g., processor(s) 31310), and/or (d) one or more memory storage devices (e.g., memory storage device(s) 3540 such as one or more internal or external memory storage units, one or more hard drives, one or more CD-ROM or DVD drives, etc.). In these or other embodiments, one or more of the input device(s) (e.g., input device(s) 3110) can be similar or identical to keyboard 104 (FIG. 1) and/or a mouse 110 (FIG. 1). Further, one or more of the display device(s) (e.g., output device(s) 3120) can be similar or identical to monitor 106 (FIG. 1) and/or screen 108 (FIG. 1). Additionally, one or more of the processors (e.g., processor(s) 31310) can be similar or identical to CPU 210 (FIG. 2). In similar or different embodiments, one or more of the memory storage devices (e.g., memory storage device(s) 3140) can be similar or identical to memory storage unit 208 (FIG. 2), external storage units coupled to input/output 112 port (FIGS. 1-2), hard drive 114 (FIG. 2), CD-ROM and/or DVD drive 116 (FIG. 2), or a detachable drive coupled to input/output port 112 (FIGS. 1-2).

The input device(s) (e.g., input device(s) 3110) and the display device(s) (e.g., output device(s) 3120) can be coupled to system 310 in a wired manner and/or a wireless manner, and the coupling can be direct and/or indirect, as well as locally and/or remotely. As an example of an indirect manner (which can or cannot also be a remote manner), a keyboard-video-mouse (KVM) switch can be used to couple the input device(s) (e.g., input device(s) 3110) and the display device(s) (e.g., output device(s) 3120) to the processor(s) (e.g., processor(s) 3130) and/or the memory storage unit(s) (e.g., memory storage device(s) 3140). In some embodiments, the KVM switch also can be part of system 310. In a similar manner, the processors and/or the non-transitory computer-readable media can be local and/or remote to each other.

Meanwhile, in many embodiments, system 310 also can be configured to communicate with one or more databases (e.g., a database(s) 330). The one or more databases can include a member database that contains information about the demographic, geographic, and/or psychographic information of members of a population (e.g., insurance policyholders for an insurance company, etc.). The demographic, geographic, and/or psychographic information of the members can include the ages, genders, residences, insurance policies, premiums, payment history, and/or claim histories for the members, for example, among other information. The one or more databases additionally can include one or more of trained machine learning (ML) and/or artificial intelligence (AI) models (the ML/AI models) used in system 300 and/or system 310. The one or more databases also can include game databases that contain information about the gaming interfaces (e.g., the executable programs of game applications or webpages, etc.). The one or more databases further can include training datasets for various ML/AI models, modules, or systems, including pricing model 31410, cognitive-factor model 31420, game-selecting model 31430, etc. The training datasets can be obtained from a third party, generated manually, and/or curated from historical input/output data of one or more pre-trained ML/AI models, etc.

The one or more databases can be stored on one or more memory storage units (e.g., non-transitory computer readable media), which can be similar or identical to the one or more memory storage units (e.g., non-transitory computer readable media) described above with respect to computer system 100 (FIG. 1). Also, in some embodiments, for any particular database of the one or more databases, that particular database can be stored on a single memory storage unit or the contents of that particular database can be spread across multiple ones of the memory storage units storing the one or more databases, depending on the size of the particular database and/or the storage capacity of the memory storage units.

The one or more databases can each include a structured (e.g., indexed) collection of data and can be managed by any suitable database management systems configured to define, create, query, organize, update, and manage database(s). Exemplary database management systems can include MySQL (Structured Query Language) Database, PostgreSQL Database, Microsoft SQL Server Database, Oracle Database, SAP (Systems, Applications, & Products) Database, and IBM DB2 Database.

Meanwhile, system 300, system 310, and/or the one or more databases (e.g., database(s) 330) can be implemented using any suitable manner of wired and/or wireless communication. Accordingly, system 300 and/or system 310 can include any software and/or hardware components configured to implement the wired and/or wireless communication. Further, the wired and/or wireless communication can be implemented using any one or any combination of wired and/or wireless communication network topologies (e.g., ring, line, tree, bus, mesh, star, daisy chain, hybrid, etc.) and/or protocols (e.g., personal area network (PAN) protocol(s), local area network (LAN) protocol(s), wide area network (WAN) protocol(s), cellular network protocol(s), powerline network protocol(s), etc.). Exemplary PAN protocol(s) can include Bluetooth, Zigbee, Wireless Universal Serial Bus (USB), Z-Wave, etc.; exemplary LAN and/or WAN protocol(s) can include Institute of Electrical and Electronic Engineers (IEEE) 802.3 (also known as Ethernet), IEEE 802.11 (also known as WiFi), etc.; and exemplary wireless cellular network protocol(s) can include Global System for Mobile Communications (GSM), General Packet Radio Service (GPRS), Code Division Multiple Access (CDMA), Evolution-Data Optimized (EV-DO), Enhanced Data Rates for GSM Evolution (EDGE), Universal Mobile Telecommunications System (UMTS), Digital Enhanced Cordless Telecommunications (DECT), Digital AMPS (IS-136/Time Division Multiple Access (TDMA)), Integrated Digital Enhanced Network (iDEN), Evolved High-Speed Packet Access (HSPA+), Long-Term Evolution (LTE), WiMAX, etc.

The specific communication software and/or hardware implemented can depend on the network topologies and/or protocols implemented, and vice versa. In many embodiments, exemplary communication hardware can include wired communication hardware including, for example, one or more data buses, such as, for example, universal serial bus(es), one or more networking cables, such as, for example, coaxial cable(s), optical fiber cable(s), and/or twisted pair cable(s), any other suitable data cable, etc. Further exemplary communication hardware can include wireless communication hardware including, for example, one or more radio transceivers, one or more infrared transceivers, etc. Additional exemplary communication hardware can include one or more networking components (e.g., modulator-demodulator components, gateway components, etc.).

In many embodiments, system 310 can be configured to transmit to a user device (e.g., user device 350) of a user, a graphical user interface (e.g., a webpage, a graphical user interface of a mobile application, etc.) for display on the user device. The graphical user interface can include one or more activation controls (e.g., a button, a hyperlink, etc.) for activating one or more gaming interfaces (e.g., loading an embedded game on the graphical user interface, starting a separate gaming mobile application, or landing a new webpage, etc.). System 310 further can determine, by any suitable approaches or ML/AI models (e.g., game-selecting model 3130), the one or more gaming interfaces from one or more available gaming interfaces based at least in part on demographic information and/or geographic information associated with the user. For example, the one or more available gaming interfaces can include a respective group of gaming interfaces for each user age group. Examples of the approaches for determining the one or more gaming interfaces can include selecting the one or more gaming interfaces randomly or based on one or more predetermined rules, etc. Exemplary algorithms for the ML/AI models (e.g., game-selecting model 3130) for determining the one or more gaming interfaces can include decision trees, K Nearest Neighbor (KNN), neural networks, CatBoost, support vector machine, etc.

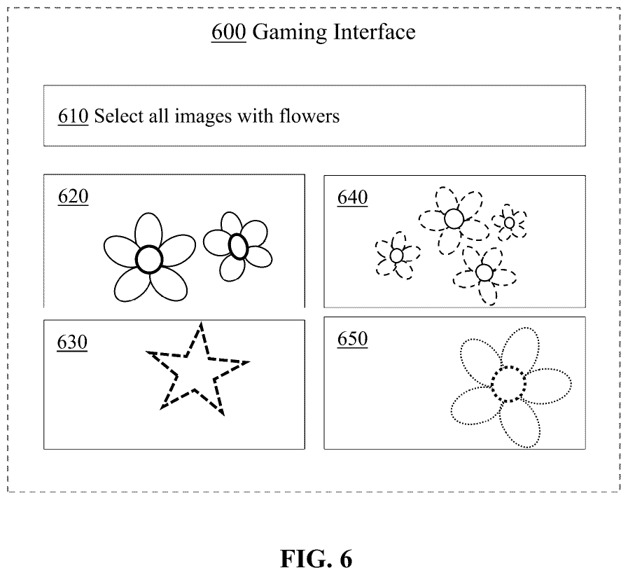

In a number of embodiments, the one or more gaming interfaces can include one or more visual prompts (e.g., icons, symbols, images, or animated images, etc.) to cause one or more user interactions with the one or more gaming interfaces by the user. Exemplary games for display on the one or more gaming interfaces can include CAPTCHA games (e.g., text-based, imaged-based, or mathematical-equation-based CAPTCHA games), Simon-type games, jigsaw puzzles, Sudoku, digit-span tests, trail making tests, flanker tasks, dual N-back tasks, simple reaction time tests, etc. FIG. 6 shows an exemplary gaming interface 600 featuring an image-based CAPTCHA game with a game instruction 610 (e.g., “Select all images with flowers”) and 4 visual prompts (e.g., tiles of images 620, 630, 640, and 650).

Still referring to FIG. 3, in many embodiments, at least one gaming interface of the one or more gaming interfaces can be configured to display at least one visual prompt of the one or more visual prompts in a random manner on the at least one gaming interface. For example, the at least one visual prompt can be displayed at one or more of a random location of the at least one gaming interface, with a random visual appearance (e.g., having a random color), with a random count of stimuli (e.g., red circles, a specific letter, etc.), or with a random sequence of the stimuli, etc.

In many embodiments, a user interaction can be observed/determined, directly or indirectly, based on one or more inputs from input device(s) 3510 of user device(s) 350. Exemplary user interactions can include clicking on a certain visual prompt within a time limit (e.g., 1 second or 2 seconds) (e.g., a CAPTCHA game), entering an answer to a simple question (e.g., entering YES or NO as an answer, the quantity of certain visual prompts (e.g., images showing apples), an answer to a math question, etc.), filling blanks in math equations (e.g., Sudoku), selecting the one or more visual prompts in a requested sequence (e.g., a Simon game), or dragging a certain visual prompt from location A to location B (e.g., jigsaw puzzles), etc.

In several embodiments, system 300, system 310, remote server 320, and/or user device 350 further can include a facial-expression-recognition model (not shown) configured to detect a user's facial expressions, a natural language processing (NPL) model (not shown) configured to determine a user's verbal comment, and/or an eye-tracking model (not shown) implemented in any suitable hardware, software, and/or firmware. In a number of embodiments, the exemplary user interactions further can include the user's facial expressions (e.g., confusion, frustration, concentration, stressed, boredom, etc.), verbal comments, and/or eye movements (e.g., gazes, pupil dilations, eye blinks, etc.) determined based on one or more images taken by a camera (e.g., camera 35110) or received by a microphone of user device 350.

In some embodiments, the at least one gaming interface further can be configured to detect gaming performance (e.g., a response or reaction time, the correctness or error rate, changes in emotions identifiable by facial expression and/or verbal comments, a frequency of expression changes, an eye-movement pattern, an eye-blink rate, a duration of a fixed gaze, etc.), by the user, associated with the at least one visual prompt. In the same or different embodiments, the graphical user interface can comprise the at least one gaming interface, or the graphical user interface can be separate from the at least one gaming interface. When the graphical user interface is separate from the at least one gaming interface, the at least one gaming interface can be displayed on an electronic device that is different from the user device that displays the graphical user interface.

In many embodiments, system 310 also can determine whether at least one of the one or more gaming interfaces is activated. At least one of the one or more gaming interfaces can be determined to be activated after system 310 (a) receives, from the user device, an activation command associated with the one or more activation controls; and (b) upon determining, based on the activation command, that at least an activated activation control of the one or more activation controls is activated, causes an activated gaming interface of the one or more gaming interfaces to be activated. System 310 can cause the activated gaming interface to be activated by any suitable approaches, including: (a) transmitting, to the user device, an activated gaming interface of the one or more gaming interfaces for display on the user device; or (b) causing the user device to load the activated gaming interface from (i) a non-transitory computer readable storage medium (e.g., a USB drive in USB port 112 (FIGS. 1-2), a CD-ROM or DVD in CD-ROM and/or DVD drive 116 (FIG. 2) or in a detachable drive coupled to input/output port 112 (FIGS. 1-2), hard drive 114 (FIG. 2)) of the user device (e.g., user device 350), or (ii) a remote server (e.g., remote server 320) for display on the user interface. In various embodiments, the activated gaming interface can be displayed in (a) the graphical user interface of the user device, (b) at least one gaming interface of the graphical user interface of the user device, (c) at least one gaming interface that is separate from the graphical user interface but that is still of the user device, or (d) at least one gaming interface that is separate from the graphical user interface and that is of an electronic device that is different from the user device.

In a number of embodiments, upon determining that a gaming interface is activated, system 310 additionally can: (a) receive, in real-time from the user device (e.g., user device 350), the one or more user interactions with the visual prompt(s) of the gaming interface; and/or (b) receive, from the user device, gaming performance data associated with the one or more user interactions. Examples of the gaming performance data can include a reaction or response time, a correctness indication, a number of trials before the user succeeds, a type of the user device, a focus span, a user's emotional response, or a frequency of presenting the one or more visual prompts, etc.

In many embodiments, system 310 further can determine, by the one or more processors and/or an ML/AI model (e.g., cognitive-factor model 3120), one or more cognitive factors for the user based on the gaming performance data. The one or more cognitive factors can be predetermined (e.g., by medical researchers) to be related to or associated with a person's abilities to perform certain task(s) (e.g., driving performance of a vehicle) and/or health or physical conditions (e.g., brain injury, stroke, insomnia, cognitive disengagement syndrome (CDS), etc.). In certain embodiments, one or more of the one or more cognitive factors can include one or more pass rates or an average pass rate of one or more games displayed on one or more gaming interfaces and played by the user, along with other data or statistics related to the user's performance in the one or more games, such as the time needed to finish the game, the number of times or frequency the game is played, the number of attempts to play the game before successfully finishing the game, etc. In a few embodiments, one or more of the one or more cognitive factors also can include responsive emotions detected while the user is interacting with the one or more games. For example, when a user looked confused, frustrated, concentrating, stressed, or bored while answering a question correctly, a cognitive factor of the cognitive factors can include these emotions, along with or instead of an indication that the user made a correct guess. In some embodiments, users with better performance at the games related to visuospatial memory, processing speed, and/or attention can be more likely to engage in unsafe driving behaviors such a distracted driving because such users may be more comfortable with multi-tasking, and the one or more cognitive factors further can include visuospatial memory, processing speed, and/or attention. In the same or different embodiments, users detected to have emotions such as confusion, frustration, and/or stress can be less likely to engage in unsafe driving behaviors, while users detected to have emotions such as concentration or boredom can be more likely to engage in unsafe driving behaviors. Similarly, users detected to have a higher pass rate, a faster pass rate, a higher frequency of play, etc. can be more likely to engage in unsafe driving behaviors. Examples of the ML/AI model for determining the one or more cognitive factors based on the gaming performance data can include a neural network model, an XGBoost model, etc.

In some embodiments, system 310 further can generate, by the one or more processors and/or an ML/AI model (e.g., pricing model 31410), an output associated with the user based at least in part on the one or more cognitive factors, as determined. Examples of the output can include a discount value for an insurance policy of the user offered by an insurance company, a likelihood of safe driving, a recommendation to seek medical care, etc. In embodiments that use a pass rate or an average pass rate as one of the one or more cognitive factors, the output can be determined based at least in part on one or more of: (a) the pass rate or the average pass rate (e.g., a likelihood of safe driving being proportional to the average pass rate, etc.), (b) whether the average pass rate reaches or exceeds a predetermined threshold (e.g., 70%, 80%, 85%, etc.), or within a predetermined range (e.g., 30-80%, 50-75%, etc.), and/or (c) a ranking of the user's performance in the age group of user, etc.

In several embodiments, one or more cognitive factors associated with a good or safe driver can include whether and/or how the user is good at multitasking. More specifically, if the user is able to successfully complete the game in the gaming interface under the predetermined conditions (e.g., within a time period) while simultaneously interacting with survey questions, application questions, other interactive media, etc. in the same or separate graphical user interface, then the user might be more prone to multitask. This success might indicate that the user is more likely to multitask while driving a vehicle, which can lead to distracted driving and potentially less safe driving. As a result, in this embodiment, this success might lead to the lack of, or a decrease in, a discount for an insurance policy premium (e.g., the output generated by system 310). In contrast, if the user is not able to successfully complete the game in the gaming interface under the predetermined conditions while simultaneously interacting with the survey questions, application questions, other interactive media, etc. in the same or separate graphical user interface, then the user might be less prone to multitask. This lack of success might indicate that the user is less likely to multitask while driving a vehicle, which can result in less distracted driving and potentially safer driving. As a result, in this embodiment, this lack of success might lead to a discount, or an increased discount, for an insurance premium (e.g., the output generated by system 310).

### Exemplary Embodiments for Providing Gaming Interfaces to Determine Cognitive Factors for a User

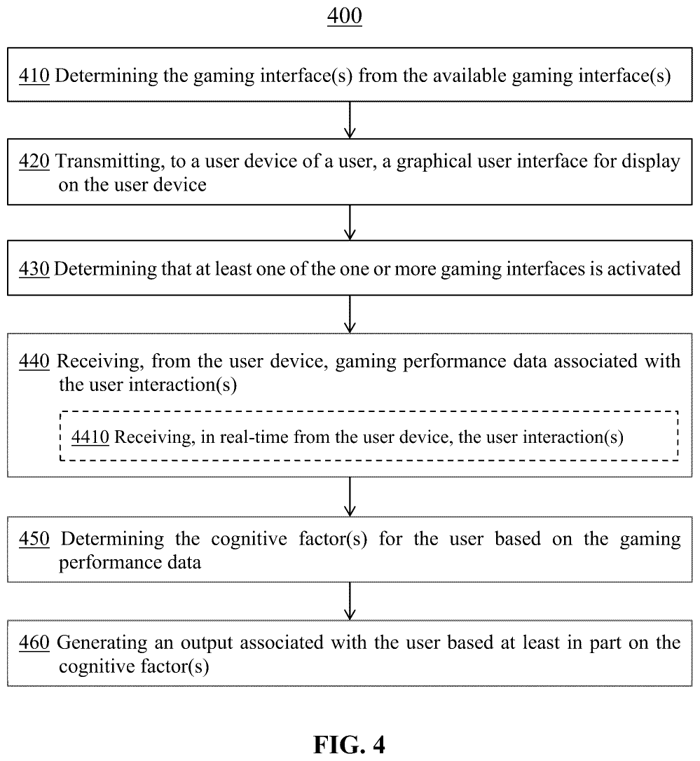

Turning ahead in the drawings, FIG. 4 illustrates actions of a method 400 for providing a graphical user interface featuring activation controls for activating gaming interfaces and generating an output based at least in part on a user's gaming performance, according to certain embodiments. Method 400 can be implemented via execution of computing instructions configured to run on one or more processors and stored on one or more non-transitory computer-readable media. Method 400 is exemplary and is not limited to the embodiments presented herein. Method 400 can be employed in many different embodiments or examples not specifically depicted or described herein.

In some embodiments, the procedures, the processes, the operations, the actions, and/or the activities of method 400 can be performed in the order presented. In other embodiments, the procedures, the processes, the operations, the actions, and/or the activities of method 400 can be performed in any suitable order. In still other embodiments, one or more of the procedures, the processes, the operations, the actions, and/or the activities of method 400 can be combined or skipped.

In many embodiments, system 300 or system 310 (FIG. 3) (including one or more of its elements, modules, and/or systems, such as pricing model 31410 (FIG. 3), etc.) can be suitable to perform method 400 and/or one or more of the operations, actions, and/or activities of method 400. In these or other embodiments, one or more of the operations, actions, and/or activities of method 400 can be implemented as one or more computing instructions configured to run on one or more processors and configured to be stored on one or more non-transitory computer readable media. Such non-transitory computer readable media can be part of a computer system such as system 300 or system 310. The processor(s) can be similar or identical to the processor(s) described above with respect to computer system 100 (FIG. 1).

Referring to FIG. 4, in many embodiments, method 400 can include a block 410 of determining one or more gaming interfaces from one or more available gaming interfaces based at least in part on demographic information or geographic information associated with a user. Block 410 can determine the one or more gaming interfaces by any suitable approaches, rules, or ML/AI models (e.g., game-selecting model 3130 (FIG. 3)). In a few embodiments, block 410 further can include, after determining the one or more gaming interfaces, generating a graphical user interface. The graphical user interface, as generated at block 410, can include: (a) one or more activation controls (e.g., buttons, checkboxes, command boxes, hyperlinks, etc.) for activating the one or more gaming interfaces, or (b) the one or more gaming interfaces (e.g., gaming interface 600 (FIG. 6)).

In many embodiments, method 400 further can include a block 420 of transmitting, to a user device (e.g., user device 350 (FIG. 3)) of a user, the graphical user interface for display on the user device. The graphical user interface can be used to display survey questions, application questions, or other interactive media for the user to interact with. In some embodiments, as explained below, the graphical user interface also can include one or more gaming interfaces, and in other embodiments, as also explained below, the display of the user device can include one or more gaming interfaces that are separate from and/or in addition to the graphical user interface.

In a number of embodiments, the computer-implemented method 400 also can include a block 430 of determining that at least one of the one or more gaming interfaces (e.g., gaming interface 600 (FIG. 6)) is activated. Block 430 can make such a determination when receiving, from the user device, an activation command associated with the one or more activation controls. In some embodiments, upon determining, based on the activation command, that at least an activation control of the one or more activation controls is activated, block 430 further can transmit, to the user device, an activated gaming interface of the one or more gaming interfaces for display on the graphical user interface or for display on the user device separate from the graphical user interface. In similar or different embodiments, upon determining that at least an activated activation control is activated, block 430 can cause the user device to load the activated gaming interface from a remote server (e.g., remote server 320 (FIG. 3)) for display on the user interface of block 420 or for display in a separate user interface on the same device or a different user device. In another exemplary embodiment, block 430 can load the activated gaming interface from a non-transitory computer readable storage medium (e.g., a USB drive in input/output port 112 (FIGS. 1-2), a CD-ROM or DVD in CD-ROM and/or DVD drive 116 (FIG. 2) or a detachable CD-ROM and/or DVD drive, hard drive 114 (FIG. 2)) of the user device for display on the user interface of block 420 or for display in a separate user interface on the same device or a different user device.

The one or more gaming interfaces (e.g., gaming interface 600 (FIG. 6)) can include one or more visual prompts (e.g., static or animated images, symbols, tiles of images 620, 630, 640, and/or 650 (FIG. 6), etc.) to cause one or more user interactions with the one or more gaming interfaces (via the one or more visual prompts or other elements of the one or more gaming interfaces) by the user. In several embodiments, at least one gaming interface of the one or more gaming interfaces can be configured to (a) display at least one visual prompt of the one or more visual prompts in a random manner on the at least one gaming interface and (b) detect a response time, by the user, associated with the at least one visual prompt. The random manner can include: (a) a random location, (b) a random visual appearance, (c) a random count of stimuli of the at least one visual prompt, (d) a random sequence of the stimuli; and/or (e) a combination thereof.

In many embodiments, method 400 additionally can include a block 440 of receiving, from the user device (e.g., user device 350 (FIG. 3)), gaming performance data associated with the one or more user interactions with the one or more visual prompts and/or other elements of the one or more gaming interfaces. Examples of the gaming performance data can include a reaction time, a correctness indication, a number of trials, a type of the user device, a focus span, a user emotional response, a frequency of changes in emotions indicated by facial expressions and/or verbal comments, and/or a frequency of presenting the one or more visual prompts, etc. In a number of embodiments, block 440 can include additional operations, actions, and/or activities. For example, block 440 further can include a block 4110 of receiving, in real-time from the user device, the one or more user interactions with the one or more visual prompts and/or other elements of the one or more gaming interfaces. In another example, block 440 further can include determining, via one or more ML/AI models, facial expressions, verbal comments, and/or eye movements based on one or more user interactions. The user can have a higher gaming performance if the gaming performance data of the user indicates a shorter time to complete the game, a higher correctness indication when interacting with the game, a lower number of trials before completing the game, a higher number of games completed, a smaller user device, a longer focus span, etc.

In many embodiments, method 400 further can include a block 450 of determining one or more cognitive factors for the user based on the gaming performance data, received at block 440. The one or more cognitive factors can be predetermined to be related to the user's driving performance of a vehicle. Examples of the driving-related cognitive factors can include age, attention, etc. In a number of embodiments, block 450 can determine the one or more cognitive factors by any suitable approaches and/or trained ML/AI models (e.g., cognitive-factor model 3120 (FIG. 3)).

In many embodiments, method 400 further can include a block 460 of generating an output associated with the user based at least in part on the one or more cognitive factors. The exemplary output can include a report with a fitness-to-drive-a-vehicle determination, a discount value for a vehicle insurance policy of the user, and/or recommendations to the user, etc. The output can indicate how likely the user is to be distracted while driving a vehicle, where a higher likelihood of distraction can result in, for example, a lower discount for a vehicle insurance policy for the user, and where a lower likelihood of distraction can result in, for example, a higher discount for a vehicle insurance policy for the user. The distraction can be determined by the gaming performance data, where a higher gaming performance in block 440 while the user is addressing the survey questions, application questions, or other interactive media in the graphical user interface of block 420 can indicate a higher tendency to multitask and can result in a higher likelihood of distraction, and where a lower gaming performance in block 440 while the user is addressing the survey questions, application questions, or other interactive media in the graphical user interface of block 420 can indicate a lower tendency to multitask and can result in a lower likelihood of distraction.

In a number of embodiments where one or more ML/AI models are used in block 410, block 440, block 450, and/or block 460, method 400 further can include pre-training and/or re-training the trained ML/AI models (e.g., pricing model 31410, cognitive-factor model 31420, game-selecting model 31430 (FIG. 3), the facial-expression-recognition model, the eye-tracking model, the NPL model, etc.) based upon historical input/output data, as determined in block 410, block 450, or block 460 respectively, feedback received from a system user (e.g., a data scientist, a machine learning engineer, etc.) or collected from various data sources (e.g., policy renewal rates, a claim increase/decrease trend, etc.), and/or synthesized training data. In these embodiments, the same or different ML/AI models can be used in one or more of block 410, block 440, block 450, and/or block 460 in method 400.

For each of the machine learning models to be retrained, the respective training datasets can be updated manually by a system user (e.g., an ML engineer, a data scientist, etc.) and/or automatically by a system (e.g., system 300 or 310 (FIG. 3)). The system user can select new training data from various data sources (e.g., websites, books, magazines, product catalogs, private third-party databases, etc.). The system can collect new training data based upon various criteria. In certain embodiments, historical input and/or output data of the model to be re-trained (e.g., pricing model 31410 (FIG. 3), cognitive-factor model 31420 (FIG. 3), game-selecting model 31430 (FIG. 3), etc.) can be used for re-training the model. In several embodiments, the historical input and/or output data of the model can be selected based upon system performance and/or user feedback from the system user associated with the historical output data. Examples of the user feedback can include a positive or negative review, a score from one to five, a follow-up action (e.g., adjusting the hyperparameters of the model(s), etc.), and so forth. In various embodiments, when more than one training dataset is used for the pre-training and/or re-training, the system (e.g., system 300 and/or system 310) can format or re-format the data of the more than one training dataset (especially when datasets are from different sources) so that the hierarchy, schema, and/or other aspects of the data of the more than one training dataset follow a common hierarchy, structure, schema, etc., and so that the data of the more than one training dataset can be more easily used to pre-train or re-train the one or more machine learning models. The system can pre-determine the common hierarchy, structure, schema, etc.

### Exemplary Content Displayed on a Display Device

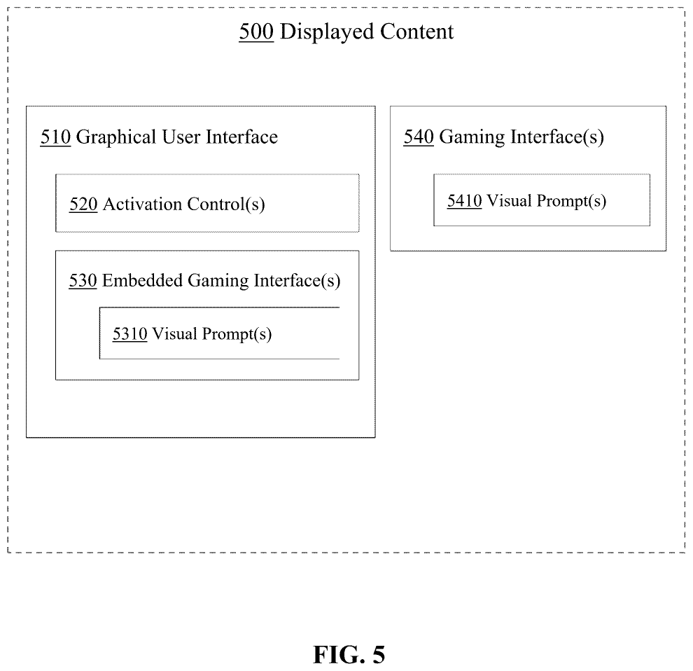

Turning ahead in the drawings, FIG. 5 illustrates an exemplary displayed content 500 displayed on a display device (e.g., monitor 106 and/or screen 108 (FIG. 1)), according to an embodiment. Displayed content 500 is merely exemplary and is not limited to the embodiments presented herein. Displayed content 500 can be employed in many different embodiments or examples not specifically depicted or described herein. In a number of embodiments, displayed content 500 can include a graphical user interface 510 and one or more gaming interface(s) 540. Graphical user interface 510 can include one or more activation control(s) 520 and/or one or more embedded gaming interface(s) 530 with one or more visual prompt(s) 5310. Gaming interface(s) 540 can include one or more visual prompt(s) 5410. In some embodiments, the user interfaces and/or portions thereof of displayed content 500 can be arranged in the layout presented. In other embodiments, the user interfaces and/or portions thereof of displayed content 500 can be arranged in any suitable layouts. In still other embodiments, one or more of the user interfaces and/or the portions of displayed content 500 can be combined or omitted. In many embodiments, system 300 (FIG. 3), system 310 (FIG. 3), or method 400 (FIG. 4) can be suitable to generate, transmit, and/or display or cause to display graphical user interface 510, embedded gaming interface(s) 530 (e.g., gaming interface 600 (FIG. 6)), visual prompt(s) 5310, gaming interface(s) 540 (e.g., gaming interface 600 (FIG. 6)), visual prompt(s) 5410 (e.g., tiles of images 620, 630, 640, and/or 650 (FIG. 6)), and/or any portions thereof.

Referring to FIG. 5, in a number of embodiments, graphical user interface 510 can be similar or identical to the graphical user interface discussed above (see, e.g., block 420 (FIG. 4)). Embedded gaming interface(s) 530 and/or gaming interface(s) 540 can be similar or identical to the one or more gaming interfaces discussed above (see, e.g., block 410, block 420, or block 4410 (FIG. 4)). Exemplary games for display on the embedded gaming interface(s) 530 and/or gaming interface(s) 540 can include CAPTCHA games, Sudoku, Simon games, etc. Visual prompt(s) 5310 and/or visual prompt(s) 5410 can be similar or identical to the one or more visual prompts discussed above (e.g., block 420 or block 4410 (FIG. 4)) or shown in FIG. 6 (e.g., tiles of images 620, 630, 640, and 650). In several embodiments, embedded gaming interface(s) can include activation control(s) 520. In similar or different embodiments, there can be no embedded gaming interface(s) 530 or gaming interface(s) 540.

### Exemplary Machine Learning Models

In many embodiments, the systems and/or methods can use one or more ML/AI models (e.g., pricing model 31410, cognitive-factor model 31420, and/or game-selecting model 31430 (FIG. 3)) to perform one or more of the above-mentioned procedures, processes, activities, actions, operations, and/or methods. Further, the systems and/or methods can use, and the one or more ML/AI models can include, one or more facial-expression-recognition models, one or more eye-tracking models, and/or one or more natural language processing (NLP) models for processing the one or more inputs and/or outputs from the one or more activation controls and/or the one or more user interactions. Examples of the algorithms used for the various ML/AI models can include bidirectional encoder representations (BERT), large language models (LLM), language models for dialogue applications (LaMDA), pathway language models (PaLM), XLNet, third generation generative pre-trained transformers (GPT-3), fourth generation generative pre-trained transformers (GPT-4), k-nearest neighbor (KNN), decision trees, linear regressions, logistic regressions, K-Means, neural networks, fuzzy logic, generative adversarial networks (GANs), condition tabular generative adversarial networks (CTGANs), convolutional neural networks (CNNs), variational autoencoders (VAEs), and so forth. In various embodiments, each of the ML/AI models used can be trained dynamically and/or regularly.

In many embodiments, the systems and/or methods can be configured to train or re-train the one or more ML/AI models. The training of each of the ML/AI models can be supervised, semi-supervised, and/or unsupervised-which in some embodiments can be followed by, or used in conjunction with, other techniques, such as re-enforcement machine learning techniques, or other techniques utilized by ChatGPT-based voice bots or virtual assistants. The training data of training datasets for pre-training or re-training each of the ML/AI models can be collected from various data sources, including historical input and/or output data by the ML/AI model. The collection and update of the training data in the training datasets can be performed once, periodically (e.g., every day, every week, etc.), or constantly. For example, in certain embodiments, the input and/or output data of an ML/AI model can be curated by a user (e.g., an ML engineer, a data scientist, etc.) or automatically collected every time the ML/AI model generates new output data to update the training datasets for re-training the ML/AI model. In many embodiments, the trained and/or re-trained ML/AI model as well as the training datasets can be stored in, updated, and accessed from a database (e.g., database(s) 330 (FIG. 3)). In the same or different embodiments, when more than one training dataset is used for the pre-training and/or re-training, the data of the more than one training dataset can be formatted or reformatted so that the hierarchy, schema, and/or other aspects of the data of the more than one training dataset (especially when datasets are from different sources) follow a common hierarchy, structure, schema, etc., and so that the data of the more than one training dataset can be more easily used to pre-train or re-train the one or more machine learning models. In many embodiments, the common hierarchy, structure, schema, etc. can be predetermined.

In some embodiments, the users, systems, and/or methods further can determine whether to add the newly created historical input and/or output data to the training dataset for retraining the ML/AI models based upon user feedback, predetermined criteria, and/or confidence scores for the historical output data. The user feedback can be associated with the output data of the ML/AI models or the output of the systems and/or methods using the ML/AI models.

In certain embodiments where machine learning techniques are not explicitly described in the processes, procedures, activities, operations, actions, and/or methods, such processes, procedures, activities, operations, actions, and/or methods can be read to include machine learning techniques suitable to perform the intended activities (e.g., determining, processing, analyzing, predicting, etc.). In several embodiments, the one or more ML/AI models can be configured to start or stop automatically upon occurrence of predefined events and/or conditions. In certain embodiments, the systems and/or methods can use a pre-trained ML/AI model, without any re-training.

### Additional Exemplary Embodiments for Providing Gaming Interfaces to Determine Cognitive Factors for a User

Various embodiments can include a method that can be implemented via execution of computing instructions configured to run on one or more processors and stored on one or more non-transitory computer-readable media. The method can include transmitting, to a user device of a user, a graphical user interface for display on the user device. The graphical user interface can include one or more activation controls for activating one or more gaming interfaces. The one or more gaming interfaces can include one or more visual prompts to cause one or more user interactions with the one or more gaming interfaces by the user.

In some embodiments, the method further can include, upon determining that at least one of the one or more gaming interfaces is activated, receiving, from the user device, gaming performance data associated with the one or more user interactions. The method also can include determining, by the one or more processors, one or more cognitive factors for the user based on the gaming performance data. In many embodiments, the method further can include generating, by the one or more processors, an output associated with the user based at least in part on the one or more cognitive factors, as determined.

In several embodiments, at least one gaming interface of the one or more gaming interfaces can be configured to (a) display at least one visual prompt of the one or more visual prompts in a random manner on the at least one gaming interface and (b) detect a response time, by the user, associated with the at least one visual prompt. The random manner can include one or more of a random location, a random visual appearance, a random count of stimuli of the at least one visual prompt, or a random sequence of the stimuli.

In a number of embodiments, the method further can include, before transmitting the graphical user interface for display on the user device, determining the one or more gaming interfaces from one or more available gaming interfaces based at least in part on demographic information or geographic information associated with the user. In a few embodiments, the method additionally can include receiving, from the user device, an activation command associated with the one or more activation controls. The method further can include, upon determining, based on the activation command, that at least an activated activation control of the one or more activation controls is activated, one or more of: (a) transmitting, to the user device, an activated gaming interface of the one or more gaming interfaces for display on the user device; or (b) causing the user device to load the activated gaming interface from (i) a non-transitory computer readable storage medium of the user device, or (ii) a remote server for display on the user interface.

In some embodiments, the method further can include, before receiving the gaming performance data, receiving, in real-time from the user device, the one or more user interactions with the one or more gaming interfaces. In a few embodiments, the gaming performance data can include one or more of: a reaction time, a correctness indication, a number of trials, a type of the user device, a focus span, a user's emotional response, or a frequency of presenting the one or more visual prompts. In a number of embodiments, the one or more cognitive factors can be predetermined to be related to driving performance of a vehicle. The output can include a discount value for an insurance policy of the user.

Various embodiments further can include a system comprising one or more processors; and one or more non-transitory computer-readable media storing computing instructions. In many embodiments, the computing instructions, when run on the one or more processors, can cause the one or more processors to perform one or more acts. The one or more acts can include transmitting, to a user device of a user, a graphical user interface for display on the user device. The graphical user interface can include one or more activation controls for activating one or more gaming interfaces. The one or more gaming interfaces can include one or more visual prompts to cause one or more user interactions with the one or more gaming interfaces by the user.

In many embodiments, the one or more acts further can include, upon determining that at least one of the one or more gaming interfaces is activated, receiving, from the user device, gaming performance data associated with the one or more user interactions. The one or more acts also can include determining, by the one or more processors, one or more cognitive factors for the user based on the gaming performance data. In addition, the one or more acts can include generating, by the one or more processors, an output associated with the user based at least in part on the one or more cognitive factors, as determined.

In a number of embodiments, at least one gaming interface of the one or more gaming interfaces can be configured to (a) display at least one visual prompt of the one or more visual prompts in a random manner on the at least one gaming interface and (b) detect a response time, by the user, associated with the at least one visual prompt. The random manner can include one or more of a random location, a random visual appearance, a random count of stimuli of the at least one visual prompt, or a random sequence of the stimuli.

In many embodiments, the one or more acts further can include before transmitting the graphical user interface for display on the user device, determining the one or more gaming interfaces from one or more available gaming interfaces based at least in part on demographic information or geographic information associated with the user. The one or more acts also can include receiving, from the user device, an activation command associated with the one or more activation controls, and upon determining, based on the activation command, that at least an activated activation control of the one or more activation controls is activated, one or more of: (a) transmitting, to the user device, an activated gaming interface of the one or more gaming interfaces for display on the user device; or (b) causing the user device to load the activated gaming interface from (i) a non-transitory computer readable storage medium of the user device, or (ii) a remote server for display on the user interface.

In some embodiments, the one or more acts further can include before receiving the gaming performance data, receiving, in real-time from the user device, the one or more user interactions with the one or more gaming interfaces. The gaming performance data can include one or more of: a reaction time, a correctness indication, a number of trials, a type of the user device, a focus span, a user's emotional response, and/or a frequency of presenting the one or more visual prompts. The one or more cognitive factors can be predetermined to be related to driving performance of a vehicle. The output can include a discount value for an insurance policy of the user.

Various embodiments further can include a non-transitory computer readable storage medium storing computing instruction, the computing instructions, when run on one or more processors, causing the one or more processors to perform one or more acts. The one or more acts can include transmitting, to a user device of a user, a graphical user interface for display on the user device. The graphical user interface can include one or more activation controls for activating one or more gaming interfaces. The one or more gaming interfaces comprise one or more gaming controls associated with one or more visual prompts to cause one or more user interactions with the one or more gaming interfaces by the user.

In many embodiments, the one or more acts further can include upon determining that at least one of the one or more gaming interfaces is activated, receiving, from the user device, gaming performance data associated with the one or more user interactions. The gaming performance data can include one or more of: a reaction time, a correctness indication, a number of trials, a type of the user device, a focus span, a user's emotional response, or a frequency of presenting the one or more visual prompts. In a number of embodiments, the one or more acts also can include determining, by the one or more processors, one or more cognitive factors for the user based on the gaming performance data. The one or more cognitive factors can be predetermined to be related to driving performance. The one or more acts additionally can include generating, by the one or more processors, an output associated with the user based at least in part on the one or more cognitive factors, as determined. The output can include a discount value for an insurance policy of the user.

In some embodiments, at least one gaming interface of the one or more gaming interfaces can be configured to (a) display at least one visual prompt of the one or more visual prompts in a random manner on the at least one gaming interface and (b) detect a response time, by the user, associated with the at least one visual prompt. The random manner can include one or more of a random location, a random visual appearance, a random count of stimuli of the at least one visual prompt, or a random sequence of the stimuli. In a number of embodiments, the one or more acts further can include before transmitting the graphical user interface for display on the user device, determining the one or more gaming interfaces from one or more available gaming interfaces based at least in part on demographic information or geographic information associated with the user.

In several embodiments, the one or more acts also can include receiving, from the user device, an activation command associated with the one or more activation controls. Upon determining, based on the activation command, that at least an activated activation control of the one or more activation controls is activated, the one or more acts further can include: (a) transmitting, to the user device, an activated gaming interface of the one or more gaming interfaces for display on the user device; and/or (b) causing the user device to load the activated gaming interface from (i) a non-transitory computer readable storage medium of the user device, or (ii) a remote server for display on the user interface. In some embodiments, the one or more acts also can include, before receiving the gaming performance data, receiving, in real-time from the user device, the one or more user interactions with the one or more gaming interfaces.

### Additional Considerations

Although providing a graphical user interface for testing cognitive factors for a user based on the user's gaming performance has been described with reference to specific embodiments, it will be understood by those skilled in the art that various changes can be made without departing from the spirit or scope of the disclosure. Accordingly, the disclosure of embodiments is intended to be illustrative of the scope of the disclosure and is not intended to be limiting.

It is intended that the scope of the disclosure shall be limited only to the extent required by the appended claims. For example, to one of ordinary skill in the art, it will be readily apparent that any element of FIG. 1-6 can be modified, and that the foregoing discussion of certain of these embodiments does not necessarily represent a complete description of all possible embodiments. Additionally, one or more of the procedures, processes, operations, actions, and/or activities of the method in FIG. 4 can include different procedures, processes, actions, and/or activities and be performed by many different modules, in many different orders. One or more elements of the displayed content in any of FIGS. 5 and 6 can include different graphical user interfaces, gaming interfaces, activation controls, and/or visual prompts, etc., and include any suitable arrangements and/or layouts. As another example, the modules, models, elements, and/or systems within system 300 or system 310 in FIG. 3 can be interchanged or otherwise modified.

Replacement of one or more claimed elements constitutes reconstruction and not repair. Additionally, benefits, other advantages, and solutions to problems have been described with regard to specific embodiments. The benefits, advantages, solutions to problems, and any element or elements that can cause any benefit, advantage, or solution to occur or become more pronounced, however, are not to be construed as critical, required, or essential features or elements of any or all of the claims, unless such benefits, advantages, solutions, or elements are stated in such claim.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

As will be appreciated based upon the foregoing specification, the above-described embodiments of the disclosure can be implemented using computer programming or engineering techniques including computer software, firmware, hardware or any combination or subset thereof. Any such resulting program, having computer-readable code means, can be embodied, or provided within one or more computer-readable media, thereby making a computer program product, e.g., an article of manufacture, according to the discussed embodiments of the disclosure. The computer-readable media can be, for example, but is not limited to, a fixed (hard) drive, diskette, optical disk, magnetic tape, semiconductor memory such as read-only memory (ROM), and/or any transmitting/receiving medium such as the Internet or other communication network or link. The article of manufacture containing the computer code can be made and/or used by executing the code directly from one medium, by copying the code from one medium to another medium, or by transmitting the code over a network.

These computer programs (also known as programs, software, software applications, “apps,” or code) include machine instructions for a programmable processor and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

As used herein, a processor can include any programmable system including systems using micro-controllers, reduced instruction set circuits (RISC), application specific integrated circuits (ASICs), logic circuits, and any other circuit or processor capable of executing the functions described herein. The above examples are example only and are thus not intended to limit in any way the definition and/or meaning of the term “processor.”

As used herein, the terms “software” and “firmware” are interchangeable and include any computer program stored in memory for execution by a processor, including RAM memory, ROM memory, EPROM memory, EEPROM memory, and non-volatile RAM (NVRAM) memory. The above memory types are example only and are thus not limiting as to the types of memory usable for storage of a computer program.

In one embodiment, a computer program is provided, and the program is embodied on a computer readable medium. In an exemplary embodiment, the system can be executed on a single computer system, without requiring a connection to a sever computer. In a further embodiment, the system is being run in a Windows® environment (Windows is a registered trademark of Microsoft Corporation, Redmond, Washington). In yet another embodiment, the system is run on a mainframe environment and a UNIX® server environment (UNIX is a registered trademark of X/Open Company Limited located in Reading, Berkshire, United Kingdom). The application is flexible and designed to run in various environments without compromising any major functionality. In some embodiments, the system includes multiple components distributed among a plurality of computing devices. One or more components can be in the form of computer-executable instructions embodied in a computer-readable medium. The systems and processes are not limited to the specific embodiments described herein. In addition, components of each system and each process can be practiced independent and separate from other components and processes described herein. Each component and process can also be used in combination with other assembly packages and processes.

As used herein, an element or step recited in the singular and preceded by the word “a” or “an” should be understood as not excluding plural elements, actions, operations, or steps, unless such exclusion is explicitly recited. Furthermore, references to “example embodiment” or “one embodiment” of the present disclosure are not intended to be interpreted as excluding the existence of additional embodiments that also incorporate the recited features.

The patent claims at the end of this document are not intended to be construed under 35 U.S.C. § 112 (f) unless traditional means-plus-function language is expressly recited, such as “means for” or “step for” language being expressly recited in the claim(s).

For simplicity and clarity of illustration, the drawing figures illustrate the general manner of construction, and descriptions and details of well-known features and techniques can be omitted to avoid unnecessarily obscuring the present disclosure. Additionally, elements in the drawing figures are not necessarily drawn to scale. For example, the dimensions of some of the elements in the figures can be exaggerated relative to other elements to help improve understanding of embodiments of the present disclosure. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but can include other elements not expressly listed or inherent to such process, method, system, article, device, or apparatus.

The terms “couple,” “coupled,” “couples,” “coupling,” and the like should be broadly understood and refer to connecting two or more elements mechanically and/or otherwise. Two or more electrical elements can be electrically coupled together, but not be mechanically or otherwise coupled together. Coupling can be for any length of time, e.g., permanent or semi-permanent or only for an instant. “Electrical coupling” and the like should be broadly understood and include electrical coupling of all types. The absence of the word “removably,” “removable,” and the like near the word “coupled,” and the like does not mean that the coupling, etc. in question is or is not removable.

As defined herein, “approximately” may, in some embodiments, mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

This written description uses examples to disclose the disclosure, including the best mode, and to enable any person skilled in the art to practice the disclosure, including making and using any devices or computer systems and performing any incorporated computer-based or computer-implemented methods. The patentable scope of the disclosure is defined by the claims, and can include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A method being implemented via execution of computing instructions configured to run on one or more processors and stored on one or more non-transitory computer-readable media, the method comprising:
transmitting, to a user device of a user, a graphical user interface for display on the user device, wherein the graphical user interface comprises one or more activation controls for activating one or more gaming interfaces that comprise one or more visual prompts to cause one or more user interactions with the one or more gaming interfaces by the user;
upon determining that at least one of the one or more gaming interfaces is activated, receiving, from the user device, gaming performance data associated with the one or more user interactions;
determining, by the one or more processors, one or more cognitive factors for the user based on the gaming performance data; and
generating, by the one or more processors, an output associated with the user based at least in part on the one or more cognitive factors, as determined.

2. The method in claim 1, wherein:
at least one gaming interface of the one or more gaming interfaces is configured to (a) display at least one visual prompt of the one or more visual prompts in a random manner on the at least one gaming interface, and (b) detect a response time, by the user, associated with the at least one visual prompt; and
the random manner comprises one or more of a random location, a random visual appearance, a random count of stimuli of the at least one visual prompt, or a random sequence of the stimuli.

3. The method in claim 1, further comprising, before transmitting the graphical user interface for display on the user device, determining the one or more gaming interfaces from one or more available gaming interfaces based at least in part on demographic information or geographic information associated with the user.

4. The method in claim 1, further comprising:
receiving, from the user device, an activation command associated with the one or more activation controls; and
upon determining, based on the activation command, that at least an activated activation control of the one or more activation controls is activated, one or more of:
transmitting, to the user device, an activated gaming interface of the one or more gaming interfaces for display on the user device; or
causing the user device to load the activated gaming interface from (a) a non-transitory computer readable storage medium of the user device, or (b) a remote server for display on the user device.

5. The method in claim 1, further comprising:
before receiving the gaming performance data, receiving, in real-time from the user device, the one or more user interactions with the one or more gaming interfaces.

6. The method in claim 1, wherein the gaming performance data comprises one or more of: a reaction time, a correctness indication, a number of trials, a type of the user device, a focus span, an emotional response, or a frequency of presenting the one or more visual prompts.

7. The method in claim 1, wherein one or more of:
the one or more cognitive factors are predetermined to be related to driving performance of a vehicle; or
the output comprises a discount value for an insurance policy of the user.

8. A system comprising:
one or more processors; and
one or more non-transitory computer-readable media storing computing instructions that, when run on the one or more processors, cause the one or more processors to perform:
transmitting, to a user device of a user, a graphical user interface for display on the user device, wherein the graphical user interface comprises one or more activation controls for activating one or more gaming interfaces that comprise one or more visual prompts to cause one or more user interactions with the one or more gaming interfaces by the user;
upon determining that at least one of the one or more gaming interfaces is activated, receiving, from the user device, gaming performance data associated with the one or more user interactions;
determining, by the one or more processors, one or more cognitive factors for the user based on the gaming performance data; and
generating, by the one or more processors, an output associated with the user based at least in part on the one or more cognitive factors, as determined.

9. The system in claim 8, wherein:
at least one gaming interface of the one or more gaming interfaces is configured to (a) display at least one visual prompt of the one or more visual prompts in a random manner on the at least one gaming interface, and (b) detect a response time, by the user, associated with the at least one visual prompt; and
the random manner comprises one or more of a random location, a random visual appearance, a random count of stimuli of the at least one visual prompt, or a random sequence of the stimuli.

10. The system in claim 8, wherein the computing instructions, when run on the one or more processors, further cause the one or more processors to perform:
before transmitting the graphical user interface for display on the user device, determining the one or more gaming interfaces from one or more available gaming interfaces based at least in part on demographic information or geographic information associated with the user.

11. The system in claim 8, wherein the computing instructions, when run on the one or more processors, further cause the one or more processors to perform:
receiving, from the user device, an activation command associated with the one or more activation controls; and
upon determining, based on the activation command, that at least an activated activation control of the one or more activation controls is activated, one or more of:
transmitting, to the user device, an activated gaming interface of the one or more gaming interfaces for display on the user device; or
causing the user device to load the activated gaming interface from (a) a non-transitory computer readable storage medium of the user device, or (b) a remote server for display on the user device.

12. The system in claim 8, wherein the computing instructions, when run on the one or more processors, further cause the one or more processors to perform:
before receiving the gaming performance data, receiving, in real-time from the user device, the one or more user interactions with the one or more gaming interfaces.

13. The system in claim 8, wherein the gaming performance data comprises one or more of: a reaction time, a correctness indication, a number of trials, a type of the user device, a focus span, an emotional response, or a frequency of presenting the one or more visual prompts.

14. The system in claim 8, wherein one or more of:
the one or more cognitive factors are predetermined to be related to driving performance of a vehicle; or
the output comprises a discount value for an insurance policy of the user.

15. A non-transitory computer readable storage medium storing computing instructions, the computing instructions, when run on one or more processors, causing the one or more processors to perform:
transmitting, to a user device of a user, a graphical user interface for display on the user device, wherein the graphical user interface comprises one or more activation controls for activating one or more gaming interfaces that comprise one or more gaming controls associated with one or more visual prompts to cause one or more user interactions with the one or more gaming interfaces by the user;
upon determining that at least one of the one or more gaming interfaces is activated, receiving, from the user device, gaming performance data associated with the one or more user interactions;
determining, by the one or more processors, one or more cognitive factors for the user based on the gaming performance data; and
generating, by the one or more processors, an output associated with the user based at least in part on the one or more cognitive factors, as determined.

16. The non-transitory computer readable storage medium in claim 15, wherein:
at least one gaming interface of the one or more gaming interfaces is configured to (a) display at least one visual prompt of the one or more visual prompts in a random manner on the at least one gaming interface, and (b) detect a response time, by the user, associated with the at least one visual prompt; and
the random manner comprises one or more of a random location, a random visual appearance, a random count of stimuli of the at least one visual prompt, or a random sequence of the stimuli.

17. The non-transitory computer readable storage medium in claim 15, wherein the computing instructions, when run on the one or more processors, further cause the one or more processors to perform:
before transmitting the graphical user interface for display on the user device, determining the one or more gaming interfaces from one or more available gaming interfaces based at least in part on demographic information or geographic information associated with the user.

18. The non-transitory computer readable storage medium in claim 15, wherein the computing instructions, when run on the one or more processors, further cause the one or more processors to perform:
receiving, from the user device, an activation command associated with the one or more activation controls; and
upon determining, based on the activation command, that at least an activated activation control of the one or more activation controls is activated, one or more of:
transmitting, to the user device, an activated gaming interface of the one or more gaming interfaces for display on the user device; or
causing the user device to load the activated gaming interface from (a) a non-transitory computer readable storage medium of the user device, or (b) a remote server for display on the user device.

19. The non-transitory computer readable storage medium in claim 15, wherein the computing instructions, when run on the one or more processors, further cause the one or more processors to perform:
before receiving the gaming performance data, receiving, in real-time from the user device, the one or more user interactions with the one or more gaming interfaces.

20. The non-transitory computer readable storage medium in claim 15, wherein one or more of:
the gaming performance data comprises one or more of: a reaction time, a correctness indication, a number of trials, a type of the user device, a focus span, an emotional response, or a frequency of presenting the one or more visual prompts;
the one or more cognitive factors are predetermined to be related to driving performance; or
the output comprises a discount value for an insurance policy of the user.
